(19) United States
(12) Patent Application Publication
(10) Pub. No.: US 2006/0037222 A1
(43) Pub. Date: Feb. 23, 2006

(54) Taggants for products and method of taggant identification

(76) Inventors: Dan Hunt, Mounds View, MN (US); Christopher Zdon, Minneapolis, MN (US); Charles S. Hanson, Lakeville, MN (US)

Correspondence Address: LADAS & PARRY LLP, 224 SOUTH MICHIGAN AVENUE, SUITE 1600, CHICAGO, IL, 60604, US

(21) Appl. No.: 10/497,102

(22) PCT Filed: Dec. 2, 2002
(86) PCT No.: PCT/US02/38329

§ 371 Date: Mar. 28, 2005

Related U.S. Application Data
(60) Provisional application No. 60/334,462, filed on Nov. 30, 2001.

(30) Foreign Application Priority Data
Nov. 30, 2001 (US) 09/997,485

(51) Int. Cl. G06K 7/00

(52) U.S. Cl. 40/326; 235/494; 283/93; 283/114

(57) ABSTRACT

The tagging of articles is performed by applying microparticle taggants to the articles by means of a coating that adheres the particles to the surface of the articles. The microparticle taggants have a specific identifiable code or other quality. The coating material and microparticles are applied to the exterior surface of the articles and dried or cured thereon. The microparticles may have a magnetically attractive quality for purpose of collection of the particles for analysis. The microparticles are washed from the surface of the articles and collected in a vessel. The microparticles in the vessel are assembled or collected by means of a magnet.

### CROSS REFERENCE TO RELATED APPLICATIONS

This application claims benefit of prior U.S. application Ser. Nos. 09/997,485 and 60/334,462, both filed Nov. 30, 2001 and expressly incorporated herein by reference.

### FIELD OF THE INVENTION

The present invention relates to the application of taggants to products and materials. The taggants may be applied to colored or treated seeds, other types of particulate, granular products, bulk materials or fluids. The present invention also relates to a method of collection of taggants for purposes of identification.

### BACKGROUND OF THE INVENTION

Manufacturers and distributors of products often desire their products to be identified within the distribution stream and after purchase. The identification information may include batch number, lot number, date of manufacture, method of manufacture, packing or shipment, etc. Another quality that may be desired to be identified is the authenticity of the product, so as to distinguish the product from unauthorized originals or counterfeits.

The qualities and compositions of bulk materials, such as liquids, slurries particulate materials or granular products, are often difficult to mark. Such bulk materials may be marked with a chemical additive, microparticle or the like for purposes of later identification. However, substantial chemical or physical analysis is often required to identify the taggant.

A variety of taggants and methods of taggant identification are known for marking bulk materials. For example, U.S. Pat. No. 4,053,433 describes a method of marking substances with microparticles encoded with an orderly sequence of visually distinguishable colored segments that can be detected with a microscope or other magnifying device.

Another known taggant system is described in International Patent Publication No. WO 00/34937, filed by Tracking Technologies, Inc. This patent publication, which is herein incorporated by reference in its entirety, describes a method of taggant identification using an assortment of colored elements, wherein each colored element represents a specific position in a binary number. A series of colored elements are combined to represent a specific, identifiable binary number.

International Patent Publication No. WO 99/455 14, also filed by Tracking Technologies, Inc. and which is also herein incorporated by reference in its entirety, describes a chemical tagging system wherein multiple chemical additives are used to create a tracking number for identification purposes.

Thus, existing tagging techniques include the use of microparticles, which are marked by chemical composition, color, shape, microscopic writing, etc. The properties of these taggants may be varied to accommodate the specific application. For example, particles may be made of a magnetic or fluorescent materials to facilitate collection, of a refractory material to enhance particle survival in an explosion, of chemically inert materials to enhance particle survival in a chemical reaction, or of non-durable, soluble or reactive materials to enhance dispersal in fluids, aerosols or powder systems.

In a particular application, seeds that have been chemically or otherwise treated are required by law to be colored as a visible indication of a chemical presence. Also, seeds that have been genetically altered or engineered may be colored to serve as an identifier of the genetic property. However, only a limited number of colors are available for such purpose and none are exclusive to specific properties. Because the distributors of these seed products have created significant value in their products, they are often able to charge higher prices as compared to non-enhanced seeds. Color treatment alone may, therefore, not be sufficient to identify the quality or authenticity of the products. Also, a determination of the authenticity of the product may be required as a condition of sale. Therefore, there is a need within the seed industry for a taggant and verification system that is easily and quickly applied. The attributes of such a system may also apply to other bulk materials, such as fertilizers, chemicals, paints, oils, plastics, pigments, clays, explosives, etc., and/or prepackaged materials, such as shampoo, conditioner, lotion, motor oils, pharmaceuticals or the like.

U.S. 2002-0129523-A1 (Hunt et al), WO99/455514 (Tracking Technologies); U.S. Pat. No. 4,606,927 (Jones); U.S. Pat. No. 4,053,433 (Lee et al); GB 1568699 (3M) are incorporated herein by reference.

Known techniques for marking individual articles include use of an adhesive coating which binds the taggant to the article.

In bulk material such as explosives it has been known to disperse particles with similarly sized bulk material and include ferromagnetic material in the taggant particles to permit isolation. This technique is not particularly useful when particle sizes are very different, for instance seed, feed particles and the like.

Seed identification problems can occur when seed is alleged to be defective, if competitors sell unlicensed proprietary product as genuine, or when a licensed grower uses crop from licensed seed as seed for subsequent crops in contravention of the license. It would be desirable to be able to identify seed by unique codes which would allow for distinguishing genuine or licensed seed from competitive, counterfeit or saved crop seed.

Marking seeds with multilayer microparticles has challenges including fixed quantity of adulterant material per seed unit, high cost, need for many codes to allow for batch code information as well as manufacturer information, etc.

### SUMMARY OF THE INVENTION

The present invention relates to the tagging of articles, such as particulate or granular type materials. The invention contemplates that a quantity of microparticles is applied to the articles or materials, with the microparticle taggant having a specific batch identifiable code or quality. The microparticles are preferably applied to the articles by being mixed with a liquid coating material, which is applied to the exterior surface of the articles and dried or cured thereon. This combination may be particularly applied to seeds which are normally color coated or include some other beneficial coating, such as a pesticide and polymer. The tagging by means of the microparticles may be performed to identify authenticity, origin, genetics, batch number, lot number, date of manufacture, method of manufacture, packing or shipment or authenticity.

In one application, the microparticles at least in part have a magnetically attractive quality, i.e., are capable of being magnetically attracted. The microparticles may also include a sequential color coding for purposes of identification.

The present invention also relates to a method of tagging articles, material or the like. A quantity of microparticles is mixed with a coating that is to be applied to the material or articles. The microparticles have a coding system that relates to a specific identifiable quality. In addition, the microparticles or a portion thereof may be capable of being magnetically attracted. The coating is dried or cured such that the microparticles adhere to the material or articles.

A portion of the present invention further contemplates a method of identifying articles having microparticles adhered thereto by means of a coating material or the like. Again, the microparticles have a coding associated therewith for purposes of identification. A sample of the articles with the microparticles thereon is collected from a batch. The sample is deposited in a collection vessel, preferably within a sieve or filter, and then washed, typically by water or other fluid. The washing of the sample removes at least a portion of the microparticles adhered to the articles. The wash liquid is collected in the vessel and the washed articles are removed from the vessel. The microparticles are then assembled, the coding is read and the coding is correlated to the associated quality. Assembly of the microparticles in the wash liquid may be by any number of methods. One method contemplated is the use of magnetically attracted microparticles. A magnet can be used to help the settling of the particles within the wash liquid. A magnetic probe may also be used to collect the microparticles for analysis.

Another aspect of the present invention is the provision of a kit for collecting taggant microparticles that are capable of being magnetically attracted. The kit includes a collection vessel and a sieve or filter for holding and retaining a quantity of articles having taggant microparticles thereon. The openings in the sieve are sufficient to permit the microparticles to pass into the collection vessel during a washing operation. Means is positioned at or adjacent the base of the collection vessel for creating a magnetic field to assist in the settling of the microparticles within the wash liquid. A magnetic probe for collecting microparticles is also provided as part of the kit. The kit further includes a collection surface on the magnetic end of the probe. The collection surface is preferably removable from the probe that may be inserted under a microscope or the like for reading of the code of the microparticles.

Other features and advantages of the present invention will be understood by those in the art on reference to the drawings and description herein.

The inventive system of releasing and collecting microparticles adhered to a bulk sample of articles substantially reduces the work and magnification which would be required to observe the particles on individual seeds and allows for taggant rates to be substantially less than one particle per seed.

### BRIEF DESCRIPTION OF THE DRAWINGS

For the purpose of illustrating the invention, there is shown in the drawings various forms that are presently preferred; it being understood, however, that this invention is not limited to the precise arrangements and constructions particularly shown.

FIG. 1 shows in cross section granular type articles having a coating material applied to the outside surface and a microparticle taggant adhered to one of the particles.

FIG. 2 shows one possible microparticle taggant for use as part of the present invention.

FIG. 3 shows a collection vessel as contemplated by the present invention for washing a sample of the tagged articles.

FIG. 4 shows the collection of microparticles by means of a magnetic probe.

FIGS. 5-9 are photographs of a test kit and its contents, illustrative of a kit embodiment of the present invention.

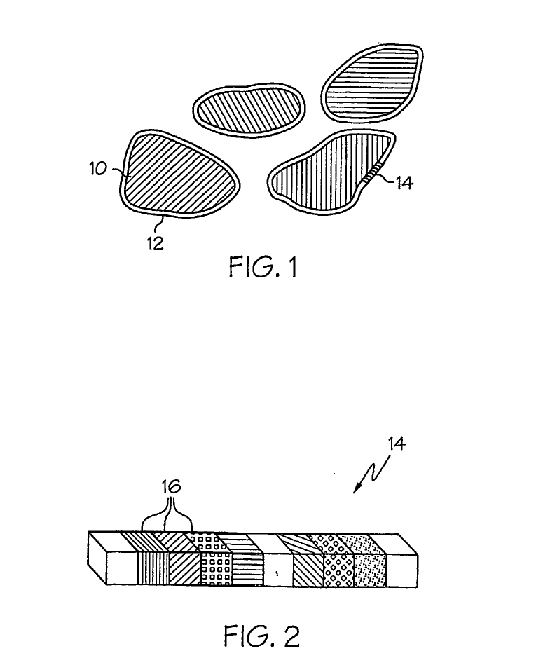

### DETAILED DESCRIPTION OF THE INVENTION

In the drawings, where like numerals identify the same or similar elements, there is shown in the figures an article which is generally referred to by the numeral 10. The article 10 may be any number of products and of any size, but is shown herein as being granular in form. In one preferred application of the present invention, the article is a seed for producing crops, flowers, trees or the like. The granular article as illustrated has a coating thereon 12. On at least some of the articles is a coded microparticle 14.

The coating 12 on the article 10 may take any form of polymer coating. As indicated one application of the present invention is the creation of a taggant system for seeds. It is Federal Law in the United States that any treated seed have a colorant added to prevent treated seed from entering the food or feedstuff markets, which could lead to accidental consumption. Colorants, such as those manufactured and sold by Becker-Underwood, Inc. of Ames, Iowa, are thus used to identify the seeds treated with active ingredients such as fungicide or insecticide. Colors may also be used to segregate genetic technologies, such as herbicide resistance. Color coding can help eliminate confusion at planting, and minimize potentially wrong chemical applications by the grower. Colorants may also be used by seed companies to give their product a distinctive look or brand identification. In addition to colorants, polymer binders may be used to control dust-off during treatment/processing, planting, and rebagging.

Colorants are typically either dyes or pigments and maybe in stored dry or in liquid form. Colorants used for seed treatment applications can be organic and inorganic. In preparing an application for the present invention, a combination of a pigment based liquid and polymer binder was used. This material was found to provide sufficient binding for the microparticles to the seeds without discoloration of the microparticles, which may prevent reading or create a false read of the associated coding.

Polymers were also used in preparing formulations for the seed taggant application. The polymer treatment of seeds is typically a macromolecular substance and can be inorganic or organic and stored in dry or liquid form. Organic polymer types used in seed treatments are natural, synthetic or semisynthetic. They also can be homo-polymers, block polymers and copolymers. Further, polymers can be water-soluble or water insoluble. Polymers used in preparing seed taggants were acrylic copolymers, polyvinyl alcohol and salts of polymeric carboxylic acid. Again, each of these materials was found to create sufficient binding effect for the microparticles and to not cause harm to the subsequent reading of the associated coding.

It should be noted that the examples listed above are not limiting on the types of coatings and polymers that may be used. Moreover, in non-seed applications a large variety of alternatives may be used. Coating formulas are often customized colorant and polymer solid-liquid suspensions. In addition, various organic colorant and polymer combinations may be used without departing from the present invention.

In testing, microparticle taggant elements were combined with polymercoatings at different concentrations from 0.05% to 1.8% by weight. It is preferred, although not required, that the taggants be combined with the polymer coatings before applying these products on the seeds or other articles.

In one working example, taggants were applied to corn seeds using a liquid polymer formulation prepared with 0.05% taggant elements. In this working example, 100 grams of seed treatment coating slurry was prepared using 2.5 grams of a polymer binder formulation and 97.5 grams water. This seed treatment coating slurry was applied at the rate of 4 ml per pound of commercial hybrid corn seed. The corn seeds were coated in a six-quart stainless steel beaker and let dry. After the coated seeds were dried the seed samples were tested for the presence of identification taggants.

The taggant microparticles may take any form desired. The microparticle must be capable of withstanding the application to the article by means of a coating or the like, and also be capable of withstanding subsequent processing of the article.

In FIG. 2 there is illustrated an example of a microparticle taggant 14 for use along with the present invention. As illustrated, the microparticle is made in accordance with U.S. Pat. No. 4,053,433, the specification of which is herein incorporated by reference in its entirety. The microparticle 14 of FIG. 2 includes a color coding consisting of a series of microscopic pieces of colored plastic film segments 16 fused together to form a rectangular “microsandwich”. The microsandwich as shown is a generally rectangular hexahedron having ten color segments provided in sequence. However, any form or shape of particle may be used, as is discussed in the above-mentioned patent. The color code may be read from left to right or right to left depending on the specifics of the application.

Another form of colored microparticle may be made by applying a colored resin to a hard, smooth substrate, such as glass. The colored resin is typically applied as a liquid, for example, by spraying onto the substrate or by spreading it out to a desired thickness using a draw-down bar. This type microparticle is describe in further detail in International Patent Publication No. WO 00/34937. In addition, the coding sequence and character may be defined according to the disclosure in this International Patent Publication.

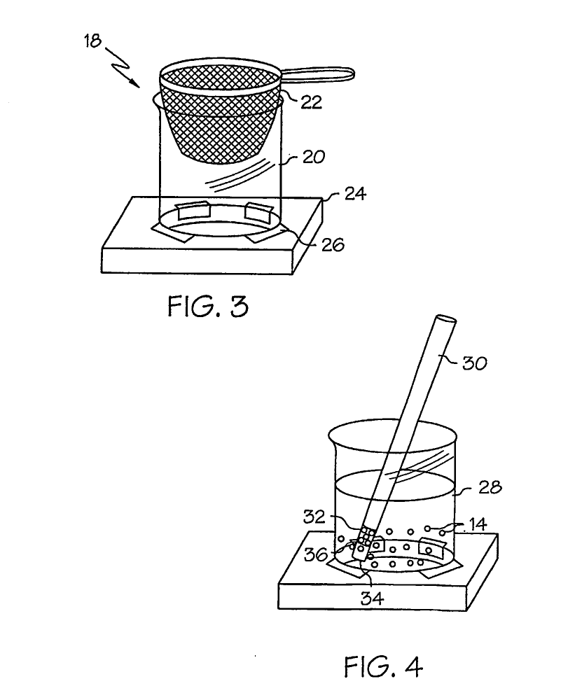

In FIG. 3 there is shown a collection vessel 18 for separating the microparticles from the coated articles. The collection vessel 18 includes a beaker or similar reservoir 20, a sieve or filter basket 22, and a base 24 having a series of magnets 26 positioned therein adjacent the bottom of the beaker 20. During use, a sample of coated articles 10 are placed in the sieve 22. A quantity of wash liquid, such as water, is poured over the articles and agitated to cause a separation of the microparticles from the articles. Other liquids or additives, such as a small amount of detergent or other surface-active ingredient, may be used to assist in the release of the microparticles. The washing and agitation time may vary depending on the type of article, coating and wash liquid. Typically, the taggants are sufficiently displaced when a significant amount of polymer coating is removed from the articles and is in solution in the wash liquid.

In the application of microparticles having a magnetically attractive quality, a magnetic field is created at the base 26 of the beaker 20 by means of permanent magnets 26. The position, number, size and strength of the magnets may vary. In addition, it is contemplated that a magnetic field can be created by electric means, if desired. The magnetic field helps to settle the microparticles, which because of their size and materials may desire to remain in suspension and/or be easily disturbed within the wash liquid.

As illustrated in FIG. 4, the microparticles 14 within the wash liquid 28 are collected by means of a collection probe or wand 30. The wand 30 has a magnet 32 on one end for attracting the microparticles 14. A collection surface 34 is wrapped around the magnetic end 32 of the wand 30. The collection surface 34 may be paper, filter paper or the like and is used to support and retain the collected microparticles for purposes of identification. A retainer ring 36 secures the collection surface 32 on the end of the wand 30. After collection of the microparticles, the wand 30 is removed from the wash liquid 28. The retainer ring 36 is then removed, permitting the separation of the collection surface 32. The surface 32 can then be placed under a microscope or the like (see FIG. 8) for analysis of the coding on the microparticles.

The method of separating and collecting the taggants is contemplated to be performed easily and quickly. Thus, a sample of articles, such as seeds, can be analyzed prior to purchase to determine the age, quality or authenticity of the products. Moreover, the simplicity of the combined elements for analysis lends itself to assembly in a kit that can be sold or provided separately from the bulk materials. Prior to purchase of the bulk materials, or prior to taking delivery, the kit can be opened and the articles tested. Assuming conformance to the predetermined or authenticated code, the bulk material purchase can be completed with reasonable certainty of the desired qualities of the product.

In preferred embodiments, a binder, suitably the polymer, binds the taggant to the seed so that it stays on the seed during handling, and then the wash liquid releases the taggant from the binder so that it can be collected from a sample of the seed. The wash liquid may release the taggant by degradation of the polymer coating or dissolution.

As an alternative to the multiple side magnets depicted in the FIG. 2, a single central magnet embedded in the base 24 may be used. The wand magnet is preferably stronger than the base magnet so that it can collect particles from the bottom where the base magnet has concentrated them. Because of this wash/concentration system it is not necessary that every seed have an associated taggant particle or even that every particle carry the full code. It is only necessary that the volume of seeds washed be sufficient to provide enough taggant particles to the beaker that all relevant particles can be seen when concentrated and collected in this manner.

FIGS. 5-9 are photographs of a test kit and its contents illustrative of a kit embodiment of the present invention.

FIG. 5 shows a field test kit microscope on the left; base surfaces, beaker and collector/sieve in the center; and a magnet tipped collection wand, extra batteries and filters on the right.

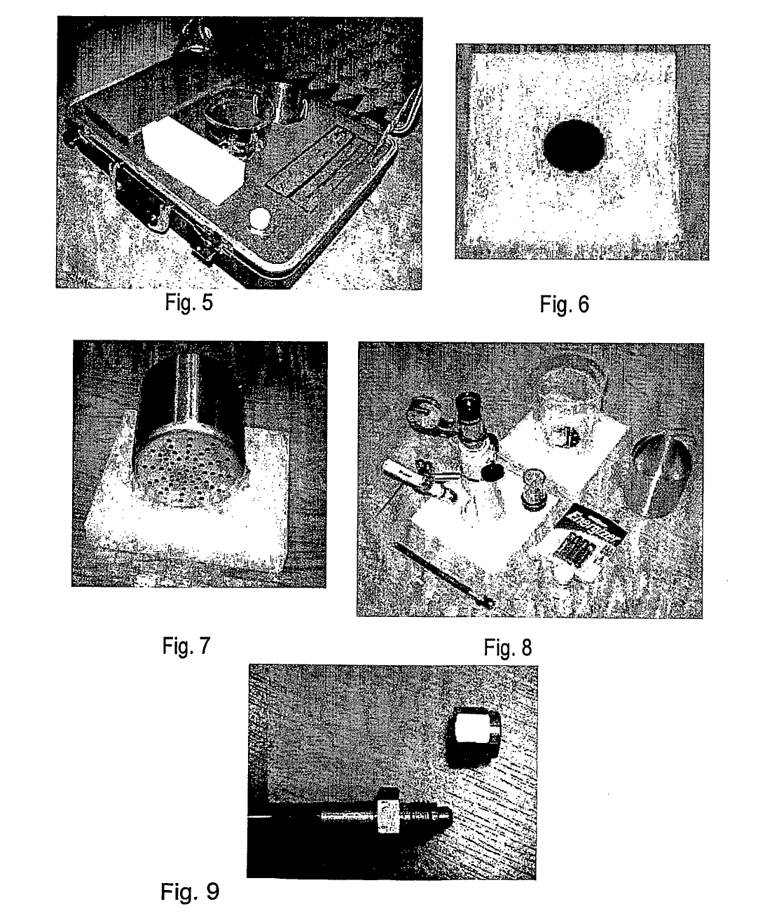

FIG. 6 shows a beaker base with magnet for taggant concentration.

FIG. 7 shows a collector/sieve. A fixed volume of seed can be collected then put into beaker which is filled with wash solvent after appropriate period the collector/sieve is removed with the seeds. The taggant particles remain behind in the beaker with the wash solvent.

FIG. 8 shows a full kit assembly showing beaker base with beaker, sieve on the side, microscope with light, extra filters, wand, beaker, collector/sieve, batteries for microscope light.

FIG. 9 shows a magnetic nut on the end of the wand which allows for collection of the concentrated taggant. Filter papers go over the nut so taggants collect on a visible surface which can be removed and examined under the microscope.

On the following pages 10-26, matter incorporated from prior application Ser. No. 09/997,485, published as U.S. 20020129523-A1, is provided to further assist in understanding the coding systems which are aspects of the present invention.

Suitably, the marker layers each comprise a distinguishably different color or color enhancer. In some embodiments, each of the specific marker layer combinations employed in the taggant has the same number of layers and/or each specific marker layer combination employs two or three layers. The taggant may be formulated with a binder, such as an adhesive or coating compositon, which fixes the taggant to the object or material.

In some embodiments of the invention, each said specific marker layer combination employs two layers, the numeric code is a binary code having a predetermined number of places and having two values at each place, each microparticle set codes for one said value in a specific place in the code and the absence of said microparticle set in the taggant codes for the other said value at said specific place.

In a further aspect of the invention, the microparticle sets employed in the taggant include at least one datum marker layer, which function to identify an orientation of the value marker layers coded and is also coded to include place information, and at least two value marker layers coded to specify a value within the place, the datum marker layer(s) being readily distinguishable from the value marker layers.

To mark an individual object, the series of microparticles are typically adhered to the object.

Preferably, each microparticle comprises at least two distinguishable colors. In some embodiments, each microparticle comprises no more than two distinguishable colors.

Methods are known for manufacturing microparticles, for example as disclosed in U.S. Pat. No. 4,053,433. Another method for manufacturing microparticles includes applying a colored resin, such as Resimene® 735, to a hard, smooth substrate, such as glass. The colored resin is typically applied as a liquid, for example, by spraying the liquid resin onto the substrate or by applying the liquid resin to the substrate and spreading it out to a desired thickness using a draw-down bar. After the first coating has dried, a second coating is applied over the first coating using a resin of a second color. After the second coating is dried, the resin is cured. Typically, the coated substrate is heated to approximately 350° F. for about 30 minutes to cure the resin. After the substrate and resin are cooled, the coating can be scraped from the substrate, for example, using a razor blade. The microparticles may then be ground and sieved to collect the desired sized particles.

The size of the microparticles can vary, depending on the object being identified. In some instances it might make sense to identify an object, for example particulate material such as fertilizer or liquid material such as shampoo, with microparticles that are about 10 microns to about 500 microns at their average cross section dimension. In contrast, it might make sense to identify a large object, such as an automobile, using microparticles that are about 0.5 millimeter to about 1 millimeter at their average cross section dimension. For other uses, particles that are greater than 1 millimeter at their average cross section dimension might be suitable, for example, to mark large particulate matter such as mulch. For many applications, microparticles that are small enough to pass through a 50-100 mesh screen are suitable. Typically, the microparticles are about 10 microns to about 500 microns at their average cross section dimension, more typically about 50 microns to about 500 microns, most typically about 50 microns to about 100 micrometers. For some applications even smaller dimensions may be employed, for instance about 0.1 microns to 10 microns.

The concentration of microparticles used to identify an object can also vary. For example, when the microparticles are used to identify a flowable material, the microparticles might be incorporated into the material at a concentration of 0.0001 to 1 part by weight for every 100 parts by weight material. If the microparticles are used to identify an individual object, the microparticles may be combined with an adhesive at a concentration of 0.0001 to 1 part by weight for every 100 parts by weight adhesive and applied to the individual object for identification purposes. Preferably, the adhesive is transparent, such that the microparticles are readily visible. Examples of suitable adhesives include lacquers and enamels, such as acrylic, alkyds, etc.

The disclosure provides a system for marking an object, for example, to indicate ownership, source or origin. The method involves the use of an assortment of microparticles that are used as a part of a coding system wherein each microparticle represents a specific place in a number. A series of microparticles can be combined to represent a number and used to mark an object. The number may be dictated from outside the microparticle system since there are no gaps in the numeric sequence.

To facilitate an understanding of the method, a brief discussion of a numeric system will first be provided.

In the decimal system, numbers are organized into numeric positions or “places.” For example, a “hundreds” place, a “tens” place, and a “ones” place such that the number “193” is 1-hundreds plus 9-tens plus 3-ones. According to this system, the “ones” place means 10⁰, the tens place means 10¹, and the hundreds place means 10². The decimal system uses the digits 0-9 to represent numbers. To represent a larger number, such as the number twelve, multiple places are used.

The binary system works under the same principles as the decimal system, only it operates in base 2 rather than base 10. In other words, instead of the places being 10², 10¹, and 10⁰, they are 2², 2¹, and 2⁰. Instead of using the digits 0-9, only the digits 0 and 1 are used. A number larger than 1, for example the number 3, is represented using multiple places. The decimal number 3 is represented by the number “11” in binary (1×2¹)+(1×2⁰).

The coding system may involve an assortment of microparticles in which each microparticle represents a specific place in a binary number, such that a series of microparticles can be combined to represent a number. In a binary system, for example, the standard may be established such that when a particle is present in a mixture, the numeric place represented by that particle contains the value “1”. If a particle corresponding to a particular numeric place is not present in a mixture, the numeric place represented by the particle contains the value “0”. Alternately, in a numeric system established for base 3, a standard may be established where the absence of a particle is represented by the value “0” at that place, the presence of a specific form of the particle (designated, for example, by color, presence or absence of a visual enhancer, shape or number of layers) represents the value “1” at that place, and a different form of the particle represents the value “2” at that place, and so on.

Each microparticle can include a single color, or a plurality of colors. Preferably, each microparticle comprises at least two distinguishable colors. In one embodiment each microparticle comprises just two distinguishable colors.

If single microparticles are made using eight different colors, 2⁸ or 256 binary numbers can be created. If the same eight colors are used to make dual-color microparticles (i.e., particles having two color layers each), 28 unique dual-color microparticles can be created (see Table 1, below). The 28 unique microparticles can be used to formulate 2²⁸, or 268 million binary numbers.

TABLE 1

| | | gold | silver | Magenta | black | green | yellow | blue | Total |
|---|---|---|---|---|---|---|---|---|---|
| 1 | red | x | x | x | x | x | x | x | 7 |
| 2 | blue | x | x | x | x | x | x | | 6 |
| 3 | yellow | x | x | x | x | x | | | 5 |
| 4 | green | x | x | x | x | | | | 4 |
| 5 | black | x | x | x | | | | | 3 |
| 6 | magenta | x | x | | | | | | 2 |
| 7 | silver | x | | | | | | | 1 |
| 8 | gold | | | | | | | | 0 |
| | | | | | | | | | 28 |

Note that at this juncture, the numbering system makes a distinctive departure from the prior art of microparticle taggants. The eight colors are no longer used to represent numeric values. Instead they are used to create a set of color combinations that is greater in number than the original eight colors and the resulting combinations are then used to represent numeric information. Values are assigned only to those combinations that are permissible in a layered taggant, so that no gaps occur in the numeric sequence. As shown in Table 1, pairing eight colors can create twenty-eight distinctive color combinations representing numeric information.

The number of microparticles possible, X, is characterized by the equation:
X=1+2+3 . . . +N
where N=K−1 and K=the number of colors available.

For example, if six colors are used, N=1+2+3+4+5=15, and so 15 paired color microparticles can be made which can formulate 2¹⁵, or 32,768 binary numbers.

If four colors are used, for example, blue, red, yellow and black, permutations of the four colors can create six distinctive microparticles: blue/red, blue/yellow, blue/black, red/yellow, red/black and yellow/black. According to the system of the invention, each of the microparticles (in this example, six dual microparticles) is assigned to represent a specific place in a binary number. A representative system is shown in Table 2 below. For purposes of this example, the standard is established in Table 2 that place #1 represents 2⁰, place #2 represents 2¹, place #3 represents 2², and so on.

TABLE 2

| Colored Particle | Binary Place |
|---|---|
| blue/red | place #1 |
| blue/yellow | place #2 |
| blue/black | place #3 |
| red/yellow | place #4 |
| red/black | place #5 |
| yellow/black | place #6 |

If, for example, three different codes are needed to mark three objects, the binary numbers 10100, 111100 and 101000 may be the binary numbers assigned to each of the items. Using the representative system shown in Table 2, above, the particle representation of the first binary number, 10100 is formulated using the particles that represent the fifth and third binary places (i.e., red/black and blue/black). An appropriate quantity of each of the red/black particles and the blue/black particles is thus combined. To formulate the particle representation of the binary number 111100, the particles representing the sixth, fifth, fourth, and third binary numeric places are combined. For the binary number 101000, the particles representing the sixth and fourth binary places are combined. Once the object is marked, identification of the object can be made by examining the series of microparticles.

Advantageously, quantitative information about the microparticles is not needed to identify the object. The presence or absence of specific microparticles need only be detected. Thus, the method is less vulnerable to problems caused by dilution and/or contamination of the material.

Additionally, the method allows for the formulation of a large set of unique microparticles, particularly microparticles that are each made up of more than one color (e.g., “multi-colored” particles). Multicolor particles require fewer colors to provide a larger number of distinctive microparticles. Multicolor microparticles are advantageous in that finding, for example, 28 distinctive colors may be difficult because of the limited number of colors to chose from. For example, rather than using permutations of eight colors to form 28 unique tags (as described above), 28 different colors would have to be used. To acquire 28 different colors, one might consider using gold, bronze, and copper. However, these colors may be difficult to differentiate from one another, particularly when admixed with other materials. Because gold, bronze and copper colors are not very distinctive from one another, use of these three colors in a system could result in errors in product identification. Thus, only one color from this group, such as gold, may be a practical choice.

In some embodiments of the invention, particles having two colored layers are preferred. Dual layer microparticles provide a great diversity of combinations while reducing the impact of byproducts. For example, during manufacturing, shipping, handling or other processing, dual layer microparticles may fracture to form single color byproducts. Because the relative size of the single colored byproduct is about 50% of the overall thickness of a dual layer microparticle, the single colored product is easily removed from the microparticles during a screening phase of production. Additionally, single colored byproduct remaining during product identification is not easily confused with a dual layer microparticle. Thus, if a single color particle, such as a solely green particle, is visible in a marked material, it can be discounted; and only paired colors, such as green/silver and green/yellow are considered as valid.

In contrast, a 5-layered particle can fracture to form 4, 3, 2 and 1-layered byproducts. However, 4 and 3-layered byproducts may be too close in size to the 5 layered particles to be effectively removed by screening during the manufacturing process (for example, a 4 layered byproduct is about 80% of the thickness of a 5 layered microparticle). Identifying 5-layered particles among 4 layered byproduct particles may make product identification more difficult. The likelihood of having a 3-layered byproduct reduces effective use of 3-layered particles in combination with 5-layered particles. Additionally, when particles are used having more than two color layers, an indicator may be necessary to denote which side of the particle represents the highest or lowest value numeric place.

According to the invention, a specific series of microparticles is used to mark an object. As used herein, the term “object” includes both solid and flowable materials. As used herein the term “flowable” refers to any material or substance that changes shape or direction uniformly in response to an external force imposed on it. The term applies to both liquids (such as oils and shampoos) and particulate matter (such as fertilizer, sand and clays). It should be noted that liquids can vary greatly in viscosity and may contain suspended particulate matter. Particulate matter can vary greatly in size and includes within its scope, fine particles with an average diameter of less than about 5 mm, and large particles with an average diameter greater than about 5 mm. Examples of flowable materials include, but are not limited to, petroleum products; personal care products such as shampoo, conditioner, lotion, cologne and perfume; pharmaceuticals, etc. The series of microparticles can be combined with a flowable material, (prepackaged or bulk) or adhered to an individual object for identification.

The microparticles may be incorporated into the material at a concentration of 0.00001 to 1 part by weight for every 100 parts by weight material. Much lower concentrations, for instance one part per ten billion by weight, or even less, can be used when suitable concentration and isolation methods are employed, such as agnetic concentration and isolation of microparticles attractive to magnets.

If the microparticles are used to mark an individual product unit, the microparticles can be combined with a binder, for instance an adhesive or coating formulation, preferably a transparent binder. Suitable binder materials are known and include lacquers and enamels such as acrylics and alkyds, hot melts, etc. The resulting particle/adhesive mixture can then be applied to the surface of an individual object for identification purposes. It should be noted that some flowable products, such as shampoos, conditioners, and lotions are often packaged. In the case of a prepackaged material, the microparticles can be combined with the packaged material, or adhered to the container or bottle, label, lid or any other packaging or shipping container.

The marked object can be subsequently identified to determine the presence or absence of microparticles. If the particles are visible to the naked eye, the examination may be performed without additional equipment. For particles that are not easily visualized by the naked eye, equipment such as a light microscope or a magnifying glass may be used. Typically, the microparticles can be examined using a common 40 and/or 100 power inspection microscope.

The presence or absence of specific microparticles is detected and recorded and a standard, such as that shown in Table 2, is consulted to determine which place in a binary number the particles represent. After determining which particles represent which binary numeric places, the specific binary number can be determined. An individual can perform the detection and analysis manually. Alternately, it is foreseen that the system can be automated such that a computer performs the detection and analysis. If desired, the microparticles can be separated from the object before examination. For example, a premium grade personal care product, such as a shampoo, conditioner, or lotion, marked with a series of microparticles can be filtered to remove the particles. The particles can then be washed dried and viewed under a microscope. Personal care products are often marked for the purpose of identifying diverters of the distribution chain. Using shampoo as an example, the microparticles may be applied to the product itself, the bottle, the label, the cap, or other packaging or shipping containers.

The end user can prepare the microparticles, or the microparticles can be “pre-manufactured”, placed in appropriate storage containers and supplied to an end user as a kit. In some embodiments, the kit could include a code key identifying the place (and value, if applicable) in a number represented by each of the microparticles. The kit may even contain an adhesive for applying the microparticles to an object. The end user may also formulate codes from an inventory of pre-manufactured microparticle sets at the time of use.

If desired, the particles may also include visual enhancers. Visual enhancers include, for example, pearlescent colorant, metal flake pigments, or glass microspheres, glitter etc. Visual enhancers provide the particle layers with a higher localized reflectance and a more characteristic appearance. Thus, the colored layers of the particles are more easily distinguished from each other, the substrate, and/or the marked material. For example, if green layers are used on a green substrate, visual identification could be difficult because the green layers might be “camouflaged” by the green background.

A visual enhancer may also be added to denote a numeric value to the microparticle. For example, a standard could be established that the absence of a colored chip denotes the value “0” for a specified place, the presence of a colored chip without enhancer denotes the value “1” for the same place, and the presence of a colored chip with a visual enhancer denotes the value “2” for the place.

The addition of visual enhancers can also be used to further differentiate color layers of the particles from one another. For example, primary colors (i.e., red, yellow and blue) are easy to distinguish from one another. However, it may be more difficult to distinguish primary colors from secondary colors (i.e., orange, green, and purple). Thus, if primary colors are used in combination with secondary colors, the thin colored layers of the microparticles may be less distinctive.

To reduce the possibility of confusion, a visual enhancer can be added to either some or all of the colors. For example, the secondary colors may include a glitter visual enhancer so that glitter-orange is less likely to be confused with (non-glitter) red or (non-glitter) yellow.

As an alternative to visually distinguishable characteristics such as color and visual enhancer features, the layers of the inventive microparticle systems may be distinguished by machine-readable characteristics. Machine-readable characteristics may include color or color enhancer characteristics difficult to distinguish visually; IR or UV absorption, reflection, fluorescence or transmission characteristics; magnetic; and/or radioactive characteristics.

Higher Numeric-Base Multiparticle Taggant Systems

If the base of the numbering system is too low, the number of particles required for a given numeric code may be impractical for many applications, thus not being suitable for many customer needs. For example, using a binary, or base 2 system, anywhere from 1 to 20 particles are needed to count to 1 million in decimal, and the number of particles changes from code to code. Thus, while dual layer particles provide many advantages, their use in the inventive system does have some disadvantages. In particular, the amount of microparticle material needed to identify a single number is widely variable, depending on the particular number coded. For instance, an adhesive or coating formulation desirably will be formulated with a specific concentration of each different particle per unit volume or weight of the formulation, the concentration being selected to be high enough such that the detection method selected for identifying the code will essentially always find at least one, and preferably more than one, of each distinct particle used in the coded number. However, for a 28 pair code system, as discussed above, the number of particles employed in a coded number can vary from 1 to 28. Thus the volume or weight amount of taggant, which the adhesive or coating formulation would need to accommodate, will vary by a multiple of 28. This can be a substantial disadvantage in many applications, such as food, pharmaceutical or agricultural products, where different or additional validity testing may be required for the range of taggant concentrations utilized. Also, many-particle numbers may have a noticeably different visual effect on the product on which the taggant is carried than the effect produced by few-particle numbers.

A related disadvantage of the two-layer particle system is a difficulty in predicting production quantities. There will be considerable differences in production weight and volume of particles needed to formulate different codes. Therefore scheduling individual particle production to coordinate with particle demand can be difficult.

On the other hand, if the base of the numbering system is too high, the number of particles that must be pre-manufactured to represent a desired number of codes becomes impractical.

Overcoming these disadvantages of the two-layer particle system, while maintaining a high number of available codes and allowing those codes to be formulated from a relatively small inventory of different pre-manufactured particles (i.e. microparticle sets), is the object of a further aspect of the invention. In this aspect of the invention, the microparticles have at least three layers, preferably three or four, most preferably three layers. Each of the microparticle sets employed in the taggant include at least one datum marker layer and at least two value marker layers. The datum marker functions to indicate orientation for the value markers, as already indicated above. However, the datum marker layer or layers is also coded to specify a place in the number code so the value markers each designate a value within the indicated place. The place code uses colors readily distinguishable from each other and from those used for value markers so that the orientation indicating datum is not confused with the place value indicating colors. In this way, more numeric information can be coded into a still manageable number of microparticle sets so that the total number of particles used in any given code may be fixed at a small number, or vary only over a small number of particle sets required for any given number and yet the range of available codeable numbers remains high.

At least two numeric places should be selectable by distinguishable datum marker layer(s) in this system. Desirably the datum marker layer(s) are selected from at least three, and in some cases suitably four or more, available distinguishable marker characteristics and the value marker layers are selected from at least four, more preferably about 6-10 distinguishable marker characteristics.

Using the same colors as the electrical color-code standard black, brown, red, orange, yellow, green, blue, violet, gray, and white, and including the colors gold and silver, a total of 12 distinctive color indicators are made available. Referring to the color scheme example in Table 1 for assignment of value indicator colors, the additional four colors of the 12 color system, i.e. brown, orange, gray and white, can be employed as datum/place markers.

Because the value indicators have orientation, each pair of value indicators can have two value assignments. For instance, with brown as a place indicator and blue and green as value indicators, then blue/green can be differentiated from green/blue in the respective particles brown/blue/green and brown/green/blue. An illustration of this orientation effect is as shown in Table 3:

TABLE 3

| | | gold | silver | magenta | black | green | yellow | blue | red | total |
|---|---|---|---|---|---|---|---|---|---|---|
| 1 | red | x | x | x | x | x | x | x | — | 7 |
| 2 | blue | x | x | x | x | x | x | — | x | 7 |
| 3 | yellow | x | x | x | x | x | — | x | x | 7 |
| 4 | green | x | x | x | x | — | x | x | x | 7 |
| 5 | black | x | x | x | — | x | x | x | x | 7 |
| 6 | magenta | x | x | — | x | x | x | x | x | 7 |
| 7 | silver | x | — | x | x | x | x | x | x | 7 |
| 8 | gold | — | x | x | x | x | x | x | x | 7 |

56

With such orientation, and an unrestricted number of particles per number, 2⁵⁵ codes can be produced in a binary code as described above. However, the number of particles necessary to represent those codes will usually be impractical.

As an alternative to a binary coding system a high-base, low-place system can be used. If twelve colors are used with four devoted to datum/place and eight devoted to value, the number of values indicated by the eight value colors is 56 (twice the 28 indicated by unoriented values) and the number of places is 4. Only 224 microparticle sets (56×4) are required to achieve 56⁴ (decimal 9,834,486) different coded numbers, and only four particles are required to express any number within that range. The 224 microparticles can be pre-manufactured as stock inventory.

Optionally null values for any place can continue to be indicated by the absence of detection of a microparticle of that place, as utilized in the binary system above, in which case the number of particles utilized to code an available number will vary from 1 to 4 in the case of a four-place taggant. If greater certainty in detection, or if greater formulation uniformity is desired, one of the available values at each place may be assigned to indicate the zero value for that place. For instance, each of the 56 pair sets in Table 3 above, can be assigned one of the values 0-55. Any number from 0-9,834,485 can then be written with exactly four particles of three layers each, using zero value particles for places which are null. In that way, for instance, if sequential place value datum indicators are brown, orange, gray and white, zero value is red/gold and 55 value is gold/red, the decimal number 55 would be indicated by the four particles
brown/gold/red;
orange/red/gold;
gray/red/gold; and
white/red/gold.

Unique numbers within the available range can be assigned randomly or in accordance with any desired protocol. With the four-place system just discussed, once the number is assigned, the corresponding taggant can be rapidly formulated merely by mixing four (or fewer) members from the stock inventory. In this way, the number of layers remains low and the total number of particles required to be manufactured remains manageable, while at the same time the variability in the number of particles required to be employed in the taggant is reduced or eliminated.

For a given number of available color indicators, and a fixed number of layers, the balance between colors allocated to place/datum indicators and to value indicators will affect the parameters of the number of available codes which can be produced, the number of particles needed to depict the codes and the inventory of particles which must be produced. This is illustrated by Table 4, which shows variations in these parameters for different allocations for a 12 color, three-layer system, assuming all codes assign a zero value in each place, and assuming that the number of particles used in a code is no more than the number of colors allocated to places. In Table 4, the columns under the heading “Maximum value per place” indicate the maximum number of codes available for each of the indicated places 2-5 when up to 5 of the available places are utilized.

TABLE 4

| | | colors | | total | | | | | |
|---|---|---|---|---|---|---|---|---|---|
| | colors | allocated | color | particles | | | | | |
| Row | allocated | as place | pairs | to form | Maximum | Maximum value per place | | | |
| # | to values | indicators | (values) | max. codes | codes | 2 pl | 3 pl | 4 pl | 5 pl |
| 1 | 11 | 1 | 110 | 110 | 110 | | | | |
| 2 | 10 | 2 | 90 | 180 | 8100 | 8100 | | | |
| 3 | 9 | 3 | 72 | 216 | 373000 | 5184 | 373000 | | |
| 4 | 8 | 4 | 56 | 224 | 9800000 | 3126 | 176000 | 9800000 | |
| 5 | 7 | 5 | 42 | 210 | 131000000 | 1764 | 74000 | 3100000 | 131000000 |
| 6 | 6 | 6 | 30 | 180 | 729000000 | 900 | 27000 | 810000 | 24000000 |
| 7 | 5 | 7 | 20 | 140 | 128000000000 | 400 | 8000 | 160000 | 3200000 |
| 8 | 4 | 8 | 12 | 96 | 430000000 | 144 | 17628 | 21000 | 249000 |
| 9 | 3 | 9 | 6 | 54 | 10000000 | 36 | 216 | 1296 | 7776 |
| 10 | 2 | 10 | 2 | 20 | 1024 | 4 | 8 | 16 | 32 |

### EXAMPLE 1

Using a color set of up to 12 colors as described previously, and with the aid of Table 4, we can select the number of colors assigned as place indicators and value indicators to design an optimal numbering system for a particular application.

In this example, a series of 3,000 numerically coded particle sets is needed to tag 3,000 batches of plastic. It is determined that each batch of plastic will need one gram of each of the component particles. It is also determined that it is important that a fixed number of particles be used to represent the codes so that when a field agent analyzes the plastic they know to look for a specific number of different particles.

From a manufacturing standpoint, it is important to minimize both the number of particles needed to represent each code and the number of different particles needed to be pre-manufactured to represent a desired number of codes. For instance, a code that needs two particles to represent all of the numeric information will require half of the manufactured material as a code that requires four particles, but some numbers of codes cannot be achieved with a two-particle, three-layer system or may be obtainable with fewer different pre-manufactured particles using a four-particle system. In high volume applications, this difference can be quite substantial, and may be the difference between a cost-effective system and one that is not.

To choose an optimal taggant system Table 4 is referenced. It can be seen what combination of place and value indicators will minimize the number of individual component particles that will be needed to make up the desired numeric codes, and what combination will minimize the number of different particles that will need to be premanufactured in order to represent the desired numeric codes. Table 4 shows that to obtain at least 3,000 codes while minimizing the number of particles required to represent each value, rows 2-4 all achieve more than 3,000 codes with two places. In row 2, starting with 12 colors, 10 can be paired as value indicators, and 2 can be assigned as place indicators. Hence, a base 90 number system with 2 numeric places is created having a maximum value of 8,100. This is more than sufficient to yield the 3,000 codes required. 123 total particles must be manufactured for 3,000 codes. In row 4, with 8 colors allocated to values, 3,126 colors are obtained with 2 place colors. Hence a base 56, with 2 numeric places is adequate to meet the objective. Only ten total colors are needed and only 109 particles must be pre-manufactured.

### EXAMPLE 2

A system which uses different datum layers can also be employed to carry different information in a multi-particle taggant, for instance, to represent different numeric features of a date code.

In this example a tagging system is needed to incorporate expiration dates into a bulk material. Several approaches can be used. First, a Julian date can be implemented, where the number of the day (1-365) is represented by one or two particles, and the year is represented by another particle. This approach would require a two or three particle system. If the system is required to span a period of twenty years, a total of only twenty year-indicator particles are needed. From Table 4 it can be seen in Row 7 that 5 value indicator colors are needed to create 20 pairs with a single datum color used to indicate the particle as carrying year information. Those 20 pairs can be assigned numeric values and then used to represent the respective years.

To minimize the number of particles in a given code for day information, the 365 day values can be represented by either one or two particles. If one particle is used to represent all 365 days we must select a numbering system that is base 365 or greater. Again, consulting Table 4 we see that with three layers and 11 value indicator colors, we do not get a base system greater than 110. See row 1. To accomplish this either more colors must be added as value indicators, more than 3 layers must be incorporated into the particle, or more than one particle must be used to represent date information.

The other options are to use a four-layer particle or 2 three-layer particles. By analogy to Table 4, it can be seen that using the colors available, more than 365 different particles can be manufactured using 4 layers. Given this approach, 20 year particles plus 365 day-particles for a total of 385 particles must be premanufactured to achieve these numbers. In actual production however, only one year particle must be manufactured each year giving a realized annual total of 365 plus 1 for a total of 366 particles per year.

If 2 three-layer particles are chosen to represent the day of the year, we can see from Table 1, row 7 that we can create 400 codes using 5 value indicator colors in 2 places, the places being indicated with 2 colors different than used to designate the year particle and different from the colors used for values in both the day and year systems. When used next to a datum layer, the 5 value indicator colors can be paired for a total of 20 value indicators. The 20 particles can be premanufactured for each of the 2 places yielding a total of 20*2=40 particles. Here, the realized annual requirement is 20=12=32 day indicator particles plus one year indicator particle for a total of 33 premanufactured particles. Over the span of 20 years this system will require 32 plus 20 particles for a total of 52 particles. This is a much simpler system than the four-layer approach discussed above.

An alternate date coding system which could be used is the Month, Day, and Year approach. With this scheme, the highest numeric value needed is 31, to represent the number of days in a month. The numbering system can be arranged into 3 particles with the datum/place layer used to distinguish Month, Day, and Year particles. Consulting Table 1 it can be seen that row 5 will give 42 value indicator pairs using 7 paired colors. So, we choose 7 value indicator colors, and 3 place indicator colors for a total of 10 colors.

Place 1, which represents the month only needs a total of 12 particles. Place 2 which represents the days of the month will need a total of 31 particles. And finally, place 3 will need 20 particles, one for each of the years. On an actualized annual basis, 12 plus 31 plus 1 particles will be need, for a total of 44 particles each year. This is sufficiently close to the 33 particles of the previous alternative to be a competitive alternative coding system.

In each of the embodiments of the invention taggants are formulated with multiple microparticle sets, the collective sets being used to code an individual number or combinations of numbers. It may be possible that the microparticle sets may employ different numbers of layers. However it is preferred that each of the microparticle sets employed in the taggants of the invention have the same number of layers. In this way, only particles showing the selected number of layers would be taken as part of the code. Microparticles showing fewer than the selected number of layers would always be recognizable as incomplete and therefore rejected. If a mixture of microparticle sets of different numbers of layers is employed, incomplete fragment particles from the higher number of layers may be mistaken as particle sets of the lesser number of layers and thus give an incorrect code reading.

Two, three and four layer particles are all easier to manufacture than 5 or higher layer particles currently employed in commercial systems. Thus, not only does the invention provide a way of formulating a large number of particle codes from a relatively small inventory of pre-manufactured particles, it also reduces manufacturing costs for the individual particles. Moreover, for a given layer thickness, fewer layers provides smaller particles, a desirable objective in many applications.

All published documents, including all US patent documents, mentioned anywhere in this application are hereby expressly incorporated herein by reference in their entirety. Any copending patent applications, mentioned anywhere in this application are also hereby expressly incorporated herein by reference in their entirety.

While the present invention has been described in connection with the preferred embodiments and with reference to the various figures, it is to be understood that other similar embodiments may be used or modifications and additions may be made to the embodiments for performing the same function of the present invention without deviating therefrom. Therefore, the present invention should not be limited to any single embodiment, but rather should be construed in breadth and scope in accordance with the recitation of the appended claims.

1. A process for identifying bulk particulate matter comprising:
a. providing a quantity of the bulk particulate matter which has been marked with a coded microparticle taggant material adhesively bound to the bulk particulate material by a releasable adhesive material and coded with identifying information;
b. activating release of the adhesive material to release the microparticle taggant from the bulk particulate matter;
c. isolating the released taggant from bulk particulate matter; and
d. reading the code from the isolated microparticle taggant.

2. A process as in claim 1 where the bulk particle material is seed.

3. A process as in claim 1 or claim 2 where the releasable adhesive material is an organic coating which is soluble or degradable in a solvent.

4. A process as in any of claims 1-3 where the taggant comprises a ferromagnetic material.

5. A process as in any of claims 1-4 where the microparticle taggant is characterized in that:
the taggant comprises a plurality of microparticles having two or more distinguishable marker layers corresponding to a predetermined numerical code,
the plurality of particles comprises a plurality of microparticle sets of at least one microparticle,
each microparticle set is characterized by a specific marker layer combination different from each other microparticle set, and
the combination of microparticle sets employed in said taggant collectively forms said numerical code.

6. A process for identifying seed comprising:
a. providing a quantity of the seed having a microparticle taggant material adhesively bound thereto by a releasable seed coating material, the taggant being releasable from the coating material upon exposure to a solvent, the taggant comprising a magnetic material and being further characterized in that:
the taggant comprises a plurality of microparticles having two or more distinguishable marker layers corresponding to a predetermined numerical identifier code,
the plurality of particles comprises a plurality of microparticle sets of at least one microparticle,
each microparticle set is characterized by a specific marker layer combination different from each other microparticle set, and
the combination of microparticle sets employed in said taggant collectively forms said numerical identifier code;
b. subjecting the seed to a said solvent to release the microparticle taggant from the seed;
c. magnetically isolating the released taggant from bulk particulate matter; and
d. reading the isolated microparticle taggant.

7. A process as in claim 6 wherein the solvent is water or a water wash composition.

8. A field kit for use in identifying a bulk particulate material marked with a coded magnetically attractive microparticle taggant material adhesively bound to the bulk particulate material by a solvent releasable adhesive material and coded with identifying information, the kit comprising:
a container for holding a sample quantity of the bulk particulate material and a solvent for releasing the adhesive material;
a magnet; and
an optical enhancer operable provide an enlarged image of a sample of microparticles.

9. A field kit as in claim 8 wherein the container includes a volumetric marker for identifying a fixed sample quantity of the bulk particulate material.

10. A field kit as in claim 8 or 9 further comprising a volumetric collector for collecting a predetermined sample quantity of the bulk particulate material.

11. A field kit as in any of claims 8-10 wherein the magnet is mounted on a stirrer and covered with a removable taggant collector.

12. A field kit as in claim 1 lwherein the removable taggant collector is a white paper.

13. A field test kit as in claim 8 further including a separation means for separating the seed from a mixture of the solvent and said taggant produced by contacting said seed with said solvent.

14. Bulk agricultural seed having a microparticle taggant material adhesively bound thereto by a seed coating which is soluble or degradable in a liquid solvent to release the taggant.

15. Bulk agricultural seed as in claim 14 wherein the taggant is characterized in that:
the taggant comprises a plurality of microparticles having two or more distinguishable marker layers corresponding to a predetermined numerical identifier code,
the plurality of particles comprises a plurality of microparticle sets of at least one microparticle,
each microparticle set is characterized by a specific marker layer combination different from each other microparticle set, and
the combination of microparticle sets employed in said taggant collectively forms said numerical identifier code.

16. Bulk agricultural seed as in claim 14 or 15 wherein the microparticle further comprises a magnetic material.

17. Bulk agricultural seed as in any of claims 14-16 wherein the taggant particles are present on the seed in an average amount of less than one said microparticle per seed.

18. Bulk agricultural seed as in any of claims 14-17 wherein said liquid solvent is water or a water-based wash composition.

19. A method of identifying articles comprising the steps of:
providing a plurality of articles, the articles having a plurality of mieroparticles adhered thereto by means of a coating material, the microparticles having a coding associated therewith for purposes of identification of the articles;
collecting a sample of the articles from the plurality;
depositing the sample in a collection vessel;
washing the sample with a liquid to remove at least a portion of the microparticles adhered to the article sample;
collecting the wash liquid and removed particles in the vessel;
removing the washed article sample from the vessel;
assembling the microparticles washed from the article sample; and
reading the coding on the microparticles and correlating the coding to the associated quality corresponding to the coding.

20. A method as claimed in claim 19 wherein the sample collection is deposited in a sieve, inserted into the collection vessel, the sieve retaining the collection during the washing step.

21. A method as claimed in claim 19 wherein the microparticles are magnetically attractive and the assembly of washed microparticles is performed by means of magnetic attraction.

22. A kit for collecting a plurality of microparticles magnetically attractive, the microparticles applied as a taggant to articles, the kit comprising:
a collection vessel;
a sieve for holding and retaining a quantity of articles having taggant microparticles thereon while also permitting microparticles to pass into the collection vessel during a washing operation;
magnetic means at the base of the collection vessel for assisting in the settling of microparticles within the wash liquid; and
a magnetic probe for collecting microparticles.

23. A process for marking an article by applying thereto a taggant, a marking formulation comprising a taggant, or an article marked with a taggant, wherein the taggant comprises a plurality of microparticles having two or more distinguishable marker layers corresponding to a predetermined numeric code, the plurality of particles comprises a plurality of microparticle sets of at least one microparticle, each microparticle set is characterized by a specific marker layer combination different from each other microparticle set, the combination of microparticle sets employed in said taggant collectively forms said numeric code,
the invention characterized in that:
the microparticle sets employed in the taggant include at least one datum marker layer coded to include place information and at least two value marker layers coded to specify a value within the place, the at least one datum marker layer being readily distinguishable from the value marker layers and functioning to identify an orientation of the value marker layers.

24. The invention of claim 23 wherein the at least one datum marker layer is selected from at least two distinguishable marker characteristics.

25. The invention of claim 24 wherein each said microparticle set is made up of three-layer particles composed of one said datum marker layer and two value marker layers.

26. The invention of claim 25 wherein each distinguishable marker characteristic is a visually distinguishable color or color enhancer or a color, magnetic or radioactive feature distinguishable by a sensing machine.

27. The invention of claim 23 wherein the marker layers each comprises a distinguishably different color or color enhancer.

28. The invention of claim 23 wherein the each said specific marker layer combination has the same number of layers.

29. The invention of claim 23 wherein each said specific marker layer combination employs three or four layers.

30. The invention of claim 23 wherein each said particle set represents a value at a given place, the at least one datum marker layer codes for said place and the combination of value marker layers codes for said value at said place.

31. The invention of claim 30 wherein the at least one datum marker layer is selected from at least two distinguishable marker characteristics, the at least two value marker layers are selected from at least three distinguishable marker characteristics, the total number of distinguishable marker characteristics is a fixed number and the number of marker characteristics allocated as datum markers and as value markers, respectively, is selected to minimize the number of different microparticles necessary to sequentially represent all values within a predetermined range of values with said fixed number of marker characteristics.

32. The invention of claim 31 wherein each said marker layer combination has three layers.

33. A process for marking an article by applying thereto a taggant, a marking formulation comprising a taggant, or an article marked with a taggant, wherein the taggant comprises a microparticle having three or more distinguishable marker layers corresponding to a predetermined numeric code, said marker layers comprising at least one datum marker layer coded to include place information and at least two value marker layers coded to specify a value within the place, the at least one datum marker layer being readily distinguishable from the value marker layers and functioning to identify an orientation of the value marker layers.

34. The invention of claim 33 wherein the combination of value marker layers collectively determines said value within said place.

35. A process for marking an article by applying thereto a taggant, a marking formulation comprising a taggant, or an article marked with a taggant, wherein the taggant comprises a microparticle having two distinguishable marker layers corresponding to a predetermined numeric code, the combination of said two marker layers determining both a numeric place and a value within said place in a binary numbering system.

36. A process for marking an article by applying thereto a taggant, a marking formulation comprising a taggant, wherein the taggant comprises a microparticle having two distinguishable marker layers of different color characteristics wherein the paired combination of color characteristics provided by said two layers codes for a numeric value.
